(19) United States
(12) Patent Application Publication
(10) Pub. No.: US 2025/0327534 A1
(43) Pub. Date: Oct. 23, 2025

(54) VALVE TRIM ASSEMBLY AND METHOD

(71) Applicant: EMERSON PROCESS MANAGEMENT (TIANJIN) VALVES CO., LTD., Tianjin (CN)

(72) Inventors: Hang Li, Tianjin City (CN); Jie Song, Tianjin (CN)

(21) Appl. No.: 19/185,642

(22) Filed: Apr. 22, 2025

(30) Foreign Application Priority Data
Apr. 23, 2024 (CN) 2024105011097

(51) Int. Cl. F16K 47/08

(52) U.S. Cl. CPC F16K 47/08

(57) ABSTRACT

A valve trim assembly for a control valve including a first sleeve having a spiral hole pattern and configured to be coupled to an outer surface of a cage assembly, a second sleeve having a spiral hole pattern and configured to be coupled to a wall of the cage assembly, and a third sleeve having a spiral hole pattern and configured to be coupled to a valve plug moveable between a closed position and an open position. The valve trim assembly also includes a first pressure recovery area disposed between the first and second sleeves, and a second pressure recovery area configured to be disposed between the cage assembly and an outer surface of the valve plug when the valve plug is in the open position.

### TECHNICAL FIELD

The present disclosure relates to valve trim assemblies for control valves and, in particular, an anti-cavitation valve trim assembly for a control valve with sleeves having a spiral hole pattern.

### BACKGROUND

Generally, it is known to use a three-stage valve trim assembly to reduce cavitation and protect a valve seat of a control valve, for example. However, many known three-stage valve trim designs include sleeves with horizontal hole patterns due to design restrictions, resulting in deadbands between the horizontal rows in the sleeves and thus a stepped flow capacity (Cv) curve of a valve cage assembly. This is typically unacceptable as it at least contributes to inaccurate control of the control valve.

An exemplary conventional three-stage valve trim assembly 10 is depicted in FIGS. 1-4. As shown in FIG. 1, the valve trim assembly 10 includes a first stage sleeve 12 disposed on a cage assembly 14, a second stage sleeve 16 installed within the cage assembly 14, and a third stage sleeve 18 disposed in a wall 20 of the cage assembly 14. Because both the first and second stage sleeves 12, 16 are installed using a shrink-fit method, the first and second stage sleeves 12, 16 must be thin for manufacturing convenience. There must also be a large enough space for pressure recovery between every adjacent two stages. Each of the sleeves 12, 16, and 18 includes a hole pattern design. While the third stage sleeve 18 in the wall 20 of the cage assembly 14 has deep enough holes 22 to provide pressure-recovery space as the wall 20 of the cage assembly 14 is thick, the second stage sleeve 16 is much thinner than the third stage sleeve 18. As a result, holes 24 in the second stage sleeve 16 do not provide enough pressure-recovery space. Grooves 26 are adopted for pressure recovery in the valve trim assembly 10, as depicted in FIG. 2. However, the grooves 26 must be horizontal and isolated from each other, which determines that the hole pattern design on the second stage sleeve 16 must also be horizontal along with the hole pattern designs of each of the first and third stage sleeves 12, as depicted in FIGS. 2-4. At least because every row is horizontal in the first, second, and third stage sleeves 12, 16, and 18, there will be deadbands between each row. As a result, the flow capacity (Cv) curve of the cage assembly is in a step-style or stepped for this conventional valve trim assembly 10, as depicted in FIG. 5.

### SUMMARY

In accordance with a first exemplary aspect, a valve trim assembly for a control valve comprises a first sleeve having a spiral hole pattern and configured to be coupled to an outer surface of a cage assembly, and a second sleeve having a spiral hole pattern and configured to be coupled to a wall of the cage assembly. The valve trim assembly also includes a third sleeve having a spiral hole pattern and configured to be coupled to a valve plug moveable between a closed position and an open position. In addition, the valve trim assembly includes a first pressure recovery area disposed between the first and second sleeves and a second pressure recovery area configured to be disposed between the cage assembly and an outer surface of the valve plug when the valve plug is in the open position.

In accordance with another exemplary aspect, a control valve comprises a valve body having an inlet and an outlet, a cage assembly disposed within the valve body, and a valve seat coupled to the cage assembly. The control valve further comprises a valve plug disposed within the cage assembly and moveable between a closed position and an open position, and a valve trim assembly. The valve trim assembly comprises a first sleeve having a spiral hole pattern and coupled to the cage assembly, a second sleeve having a spiral hole pattern and coupled to a wall of the cage assembly, and a third sleeve having a spiral hole pattern and coupled to the valve plug. The valve trim assembly also includes a first pressure recovery area disposed between the first and second sleeves, and a second pressure recovery area disposed between the cage assembly and an outer surface of the valve plug when the valve plug is in the open position.

In accordance with another exemplary aspect, a method of reducing cavitation of a valve seat of a control valve using a valve trim assembly is disclosed. The method comprises coupling a first sleeve of a valve trim assembly to an outer surface of a cage assembly, the first sleeve having a spiral hole pattern, and coupling a second sleeve of the valve trim assembly to a wall of the cage assembly, the second sleeve having a spiral hole pattern. The method also includes coupling a third sleeve of the valve trim assembly to a valve plug moveable between a closed position and an open position, the third sleeve having a spiral hole pattern. The method further comprises forming a first pressure recovery are between the first sleeve and the second sleeve, and forming a second pressure recovery area between the wall of the cage assembly and an outer surface of the valve plug when the valve plug is in the open position.

In further accordance with any one of the foregoing exemplary aspects, the valve trim assembly, the control valve, and/or the method of reducing cavitation of a control valve using a valve trim assembly may further include any one or more of the following preferred forms.

In some preferred forms, the first sleeve may be associated with a first stage of the valve trim assembly, the second sleeve may be associated with a second stage of the valve trim assembly, and the third sleeve may be associated with a third stage of the valve trim assembly.

In other preferred forms, the second sleeve may be configured to be disposed immediately adjacent to the first sleeve, such that the first sleeve surrounds the second sleeve. In addition, the third sleeve may be configured to be disposed separate from the first and second sleeves and the cage assembly and disposed around the valve plug.

In still other preferred forms, the first pressure recovery area may be disposed between the first sleeve and the second sleeve within the wall of the cage assembly, and the second pressure recovery area may be disposed between the second sleeve and the third sleeve when the valve plug is in the open position.

In still other preferred forms, the cage assembly may include a wall with an inner surface and an outer surface, and the valve plug may include a body with an outer surface, wherein the first pressure recovery area may be disposed between the inner and outer surfaces of the wall of the cage assembly, and the second pressure recovery area may be disposed between the inner surface of the wall of the cage assembly and the outer surface of the body of the valve plug when the valve plug is in the open position.

In other forms, the third sleeve may be disposed downstream a seating line of a valve seat and the valve plug when the valve plug is in the closed position, reducing risk of cavitation near the seating line.

In still other forms, a deadband of the cage assembly may be equal to a deadband of the valve plug, and the deadband of the cage assembly may be disposed at an area from a first hole at an end of the second sleeve to a seating line of the valve seat and the valve plug, and the deadband of the valve plug may be disposed at an area from a center line of a first hole at an end of the third sleeve to a seating surface of the valve seat.

In other forms, forming a first pressure recovery area between the first sleeve and the second sleeve may comprise forming the first pressure recovery area disposed between the first sleeve and the second sleeve within the wall of the cage assembly, and forming a second pressure recovery area between the wall of the cage assembly and an outer surface of the valve plug may comprise forming the second pressure recovery area between the second sleeve and the third sleeve when the valve plug is in the open position.

In still other preferred forms, forming a first pressure recovery area between the first sleeve and the second sleeve may comprise forming the first pressure recovery area between an inner surface of a wall of the cage assembly and an outer surface of the wall of the cage assembly, and forming a second pressure recovery area between the wall of the cage assembly and an outer surface of the valve plug when the valve plug is in the open position may comprise forming the second pressure recovery area between an inner surface of the wall of the cage assembly and the outer surface of a body of the valve plug when the valve plug is in the open position.

In still another preferred form, coupling a third sleeve having a spiral hole pattern to a valve plug moveable between a closed position and an open position may comprise disposing the third sleeve downstream a seating line of a valve seat and the valve plug when the valve plug is in the closed position, reducing risk of cavitation near the seating line, wherein a deadband of the cage assembly is equal to a deadband of the valve plug.

Any one or more of these aspects may be considered separately and/or combined with each other in any functionally appropriate manner. In addition, any one or more of these aspects may further include and/or be implemented in any one or more of the optional exemplary arrangements and/or features described hereinafter. These and other aspects, arrangements, features, and/or technical effects will become apparent upon detailed inspection of the figures and the following description.

### BRIEF DESCRIPTION OF THE DRAWINGS

The features of this disclosure which are believed to be novel are set forth with particularity in the appended claims. The present disclosure may be best understood by reference to the following description taken in conjunction with the accompanying drawings, in which like reference numerals identify like elements in the several figures, in which:

FIG. 1 is a sectional view of a conventional three-stage valve trim assembly for a control valve;

FIG. 2 is a view of a sleeve corresponding to a first stage of the valve trim assembly of FIG. 1;

FIG. 3A is a side view of another sleeve of the valve trim assembly of FIG. 1;

FIG. 3B is another view of the sleeve of FIG. 3A;

FIG. 4 is a view of yet another sleeve of the valve trim assembly of FIG. 1;

FIG. 5 is a graph depicting a stepped flow capacity (Cv) curve of a control valve with the valve trim assembly of FIG. 1;

FIG. 6 is a sectional view of a valve trim assembly according to the present disclosure with a control valve, a valve plug of the control valve in a closed position;

FIG. 7 is a close-up view of a portion of the valve trim assembly and the control valve of FIG. 6;

FIG. 8 is a sectional view of the valve trim assembly according to the present disclosure with the control valve, the valve plug of the control valve in an open position;

FIG. 9 is a close-up view of a portion of the valve trim assembly and the control valve of FIG. 8;

FIG. 10 is a sectional view of the cage assembly of FIG. 6, with portions of the valve trim assembly of the present disclosure coupled thereto;

FIG. 11 is a first sleeve of the valve trim assembly of the present disclosure;

FIG. 12 is a second sleeve of the valve trim assembly of the present disclosure;

FIG. 13 is a third sleeve of the valve trim assembly of the present disclosure; and

FIG. 14 is a graph depicting a non-step flow capacity (Cv) curve of a cage assembly with the valve trim assembly of FIGS. 6-13.

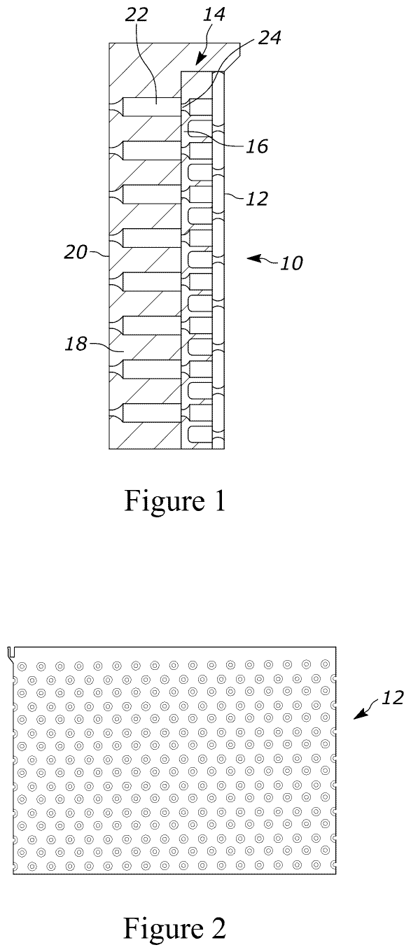

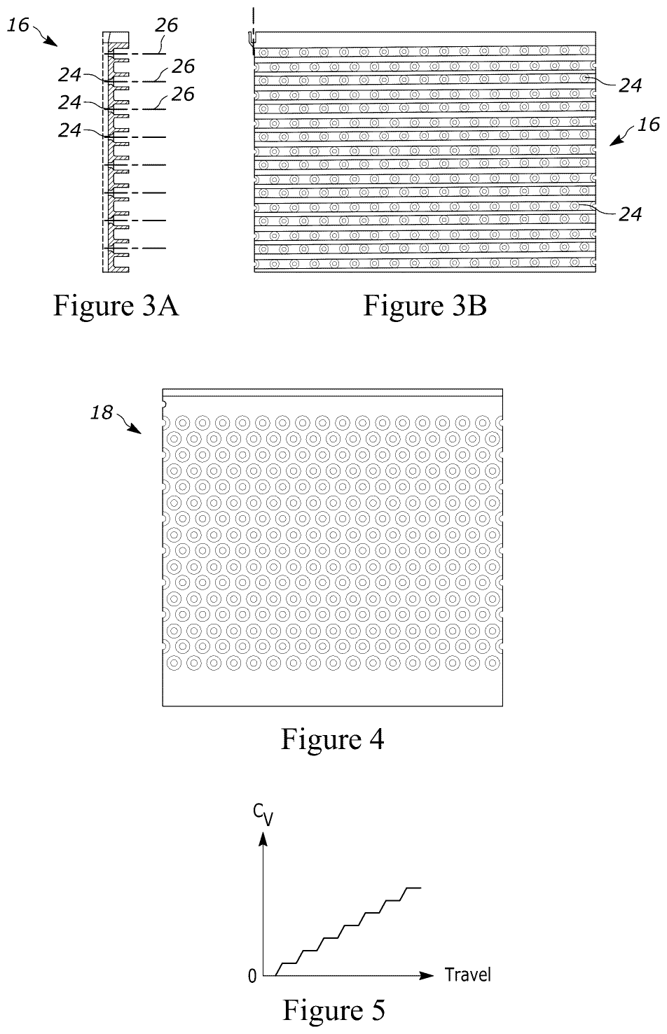

### DETAILED DESCRIPTION

A valve trim assembly for a control valve is depicted. The valve trim assembly is a three-stage valve trim assembly comprising a first sleeve having a spiral hole pattern and configured to be coupled to an outer surface of a cage assembly of the control valve. The first sleeve is associated with a first stage of the valve trim assembly. The valve trim assembly also includes a second sleeve again having a spiral hole pattern and configured to be coupled to a wall of the cage assembly. The second sleeve is associated with a second stage of the valve trim assembly. The valve trim assembly further includes a third sleeve having a spiral hole pattern and configured to be couple to a valve plug of the control valve, the third sleeve is separate from the first and second sleeves, and the valve plug is moveable between a closed position and an open position. A deadband on the cage assembly is equal to a deadband on the valve plug. In addition, the valve trim assembly includes a first pressure recovery area disposed between the first and second sleeves and a second pressure recovery area configured to be disposed between the cage assembly and an outer surface of the valve plug when the valve plug is in the open position. So configured, when the valve plug is in the open position and fluid flows through one or more of the first, second, and third sleeves, a flow capacity curve of the cage assembly is non-step.

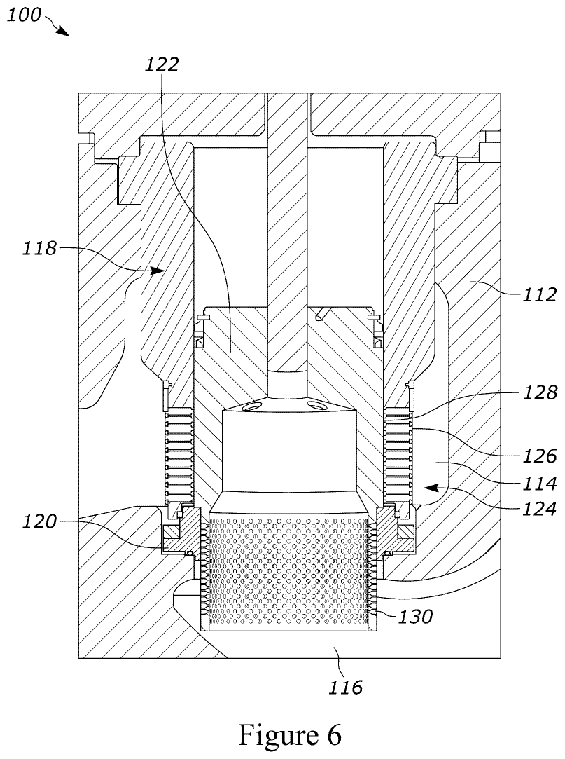

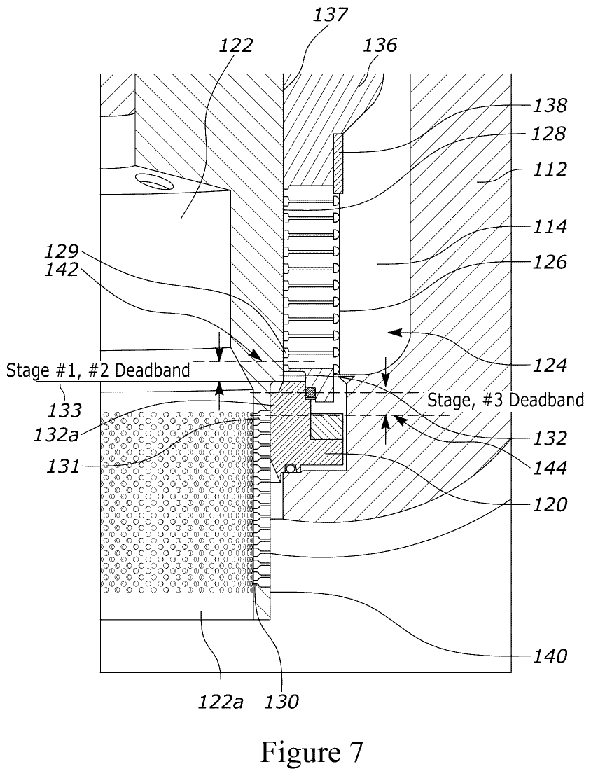

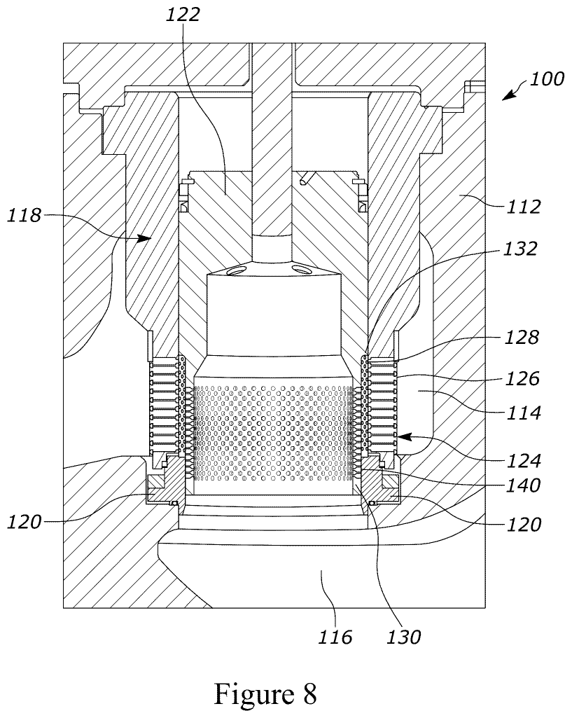

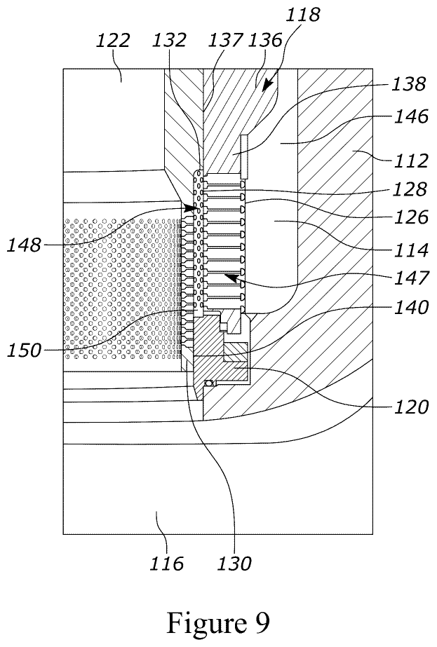

Referring now to FIG. 6, a control valve 100 having a valve trim assembly of the present disclosure is depicted. The control valve 100 includes a valve body 112 having an inlet 114 and an outlet 116, and a cage assembly 118 is disposed within the valve body 112. A valve seat 120 is coupled to the cage assembly 118, and a valve plug 122 is disposed within the cage assembly 118. The valve plug 122 is moveable between a closed position, as depicted in FIGS. 6 and 7, and an open position, as depicted in FIGS. 8 and 9 and explained more below.

The control valve 100 also includes a valve trim assembly 124 of the present disclosure. The valve trim assembly 124 includes a first sleeve 126 having a spiral hole pattern and coupled to the cage assembly 118, and a second sleeve 128 having a spiral hole pattern and coupled to a wall of the cage assembly 118. In this example, the second sleeve 128 is configured to be disposed immediately adjacent to the first sleeve 126, such that the first sleeve 126 surrounds the second sleeve 128. The valve trim assembly 118 also includes a third sleeve 130 having a spiral hole pattern and coupled to the valve plug 122, separate from the first and second sleeves 126, 128 that are coupled to the cage assembly 118. Because the second sleeve 128 is coupled to the wall of the cage assembly 118, deep hole design of the second sleeve 128 is feasible for pressure recovery, for example, and the hole pattern of each of the first, second and third sleeves 126, 128, 130 can be spiral. So configured, when the valve plug 122 is in the open position and fluid flows through one or more of the first, second, and third sleeves 126, 128, 130, a flow capacity (Cv) curve of the cage assembly 118 is non-step.

Referring now to FIG. 7, a close-up view of the valve trim assembly 124 of FIG. 6 is depicted. In this closed position of the valve plug 122, a seating surface 132 of the valve plug 122 contacts the valve seat 120 forming a seating line 133. So configured, the third sleeve 130 is disposed downstream the seating line 133 of the valve seat 120 and the valve plug 122 when the valve plug 122 is in the closed position of FIGS. 6 and 7, reducing the risk of cavitation near the seating line 133.

As further depicted in FIG. 7, the cage assembly 118 includes a wall 136 with an inner surface 137 and an outer surface 138. The valve plug 122 includes a body 122a with an outer surface 140. The first sleeve 126 is coupled to the outer surface 138 of the wall 136 of the cage assembly 118, and the second sleeve 128 is coupled to the inner surface 137 of the wall 136 of the cage assembly 118. The third sleeve 130 is coupled to the outer surface 140 of the body 122a of the valve plug 122.

In the three-stage valve trim assembly 124, it will be appreciated that the first sleeve 126 is associated with a first stage of the valve trim assembly 124, the second sleeve 128 is associated with a second stage of the valve trim assembly 124, and the third sleeve 130 is associated with a third stage of the valve trim assembly 124. As further depicted in FIG. 7, a deadband 142 of the cage assembly 118 is equal to a deadband 144 of the valve plug 122. More specifically, the deadband 142 of the cage assembly 118 is associated with the first and second stages of the first and second sleeves 126, 128 of the valve trim assembly 124 coupled to the cage assembly 118. The deadband 142 of the cage assembly 118 is disposed at an area extending from a center line of a first hole 129 at a first end 128a (FIG. 12) of the second sleeve 128 to the seating line 133 of the valve seat 120 and the valve plug 122, as depicted in FIG. 7. The deadband 144 of the valve plug 122 is associated with the third stage of the third sleeve 130 of the valve trim assembly 124. The deadband 144 of the valve plug 122 is disposed at an area extending from a center line of a first hole 131 (FIG. 13) at a second end 130b of the third sleeve 130 to another seating surface 132a of the valve seat 120.

Referring now to FIGS. 8 and 9, sectional views of the valve trim assembly 124 with the valve plug 122 of the control valve 100 in an open position are depicted. In the open position, the seating surface 132 of the valve plug 122 is moved away from contact with the valve seat 120. As a result, the third sleeve 130 coupled to the valve plug 122 is now disposed adjacent to the first and second sleeves 126, 128 and fluid is able to flow through the inlet 114 of the control valve 100. After flowing through the inlet 114, fluid then flows through the first sleeve 126 associated with the first stage and into a first pressure recovery area 146 formed by a plurality of channels 147 in the wall 136 of the cage assembly 118. As depicted in FIG. 9, the first pressure recovery area 146 is disposed between the first and second sleeves 126, 128 and the inner surface 137 and the outer surface 138 of the wall 136 of the cage assembly 118. Fluid then flows through the second sleeve 128 associated with the second stage and into a second pressure recovery area 148 disposed between the inner surface 137 of the wall 136 of the cage assembly 118 and the outer surface 140 of the valve plug 122 when the valve plug 122 is in the open position. Said another way, the first pressure recovery area 146 is disposed between the first sleeve 126 and the second sleeve 128, and the second pressure recovery area 148 is disposed in a cavity 150 between the second sleeve 128 and the third sleeve 130.

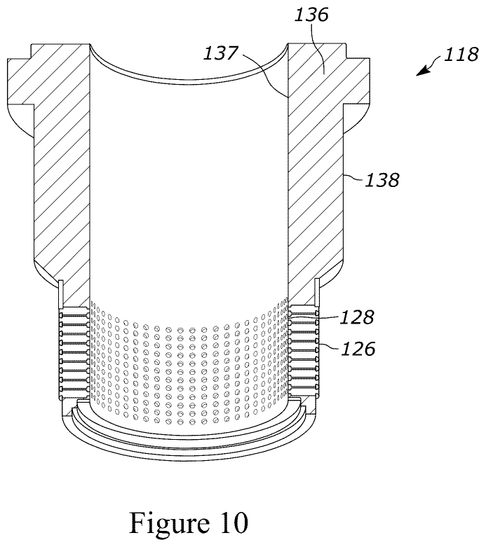

Referring now to FIG. 10, a sectional view of the cage assembly 118 having a portion of the valve trim assembly 124 of the present disclosure coupled thereto is depicted. Specifically, the first and second sleeves 126, 128 are coupled to the cage assembly 118. The first sleeve 126 is coupled to the outer surface 138 of the wall 136 of the cage assembly 118. The second sleeve 128 is coupled to the wall 136 of the cage assembly 118 and disposed between the inner and outer surfaces 137, 138 of the wall 136 of the cage assembly 118.

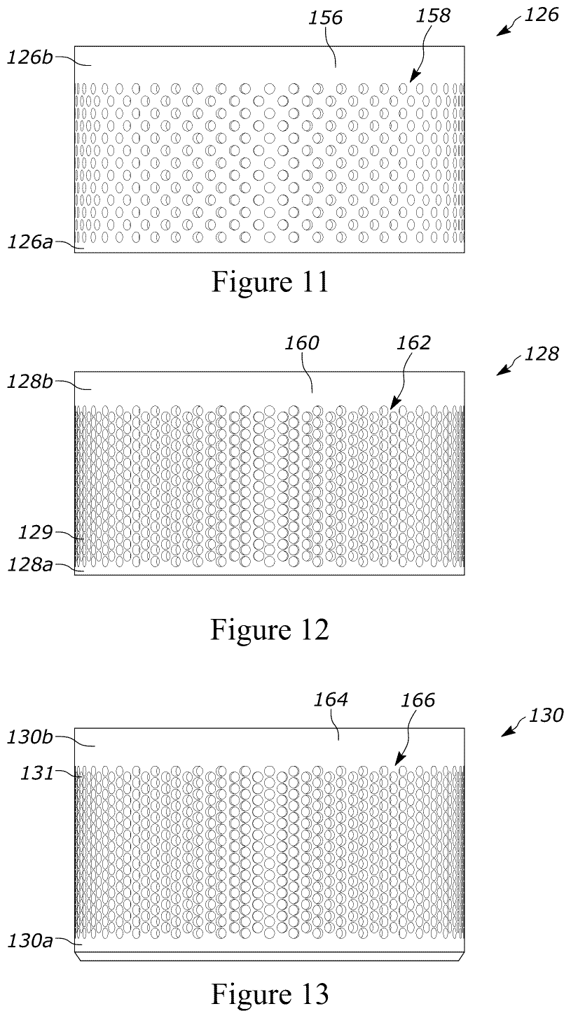

Referring now to FIGS. 11-13, each of the first, second and third sleeves 126, 128, 130 of the valve trim assembly 124 of the present disclosure is depicted. The first sleeve 126 of FIG. 11 includes a first end 126a, a second end 126b, and a cylindrical body 156 having a spiral hole pattern 158 disposed thereon. Likewise, the second sleeve 128 of FIG. 12 includes a first end 128a, a second end 128b, and a cylindrical body 160 having a spiral hole pattern 162 disposed thereon. The spiral hole pattern 162 includes a first hole 129 disposed near the first end 128a of the second sleeve 128. The first hole 129 is used to determine an area for the deadband of the cage assembly 118, as described above. The third sleeve 130 of FIG. 13 includes a first end 130a, a second end 130b, and a cylindrical body 164 having a spiral hole pattern 166 disposed thereon. The spiral hole pattern 166 includes a first hole 131 disposed near the second end 130b of the third sleeve 130 and is used to determine an area for the deadband of the valve plug 122, as also described above. Each of the spiral hole pattern 158 of the first sleeve 126, the spiral hole pattern 162 of the second sleeve 128, and the spiral hole pattern 166 of the third sleeve 130 have various columns of holes, which may be disposed along a vertical axis of the first, second and third sleeves 126, 128, 130, for example. The columns are immediately adjacent to one another. In this example, the holes in each column are offset from the holes in an immediately adjacent column in each spiral hole pattern 158, 162, and 166, respectively. In addition, each spiral hole pattern 158, 162, 166 of the first, second and third sleeves 126, 128, 130, respectively, also includes holes disposed along a circumference of the first, second and third sleeves 126, 128, 130, for example. The holes along the circumference may or may not be disposed along the same horizontal and/or circumferential plane, for example. It will be appreciated that the spiral hole patterns 158, 162, 166 may include any spiral hole pattern known and understood by those of ordinary skill in the art to achieve the same functions described herein relative to the first, second and third sleeves 126, 128, 130 of the valve trim assembly, for example, and still fall within the scope of the present disclosure.

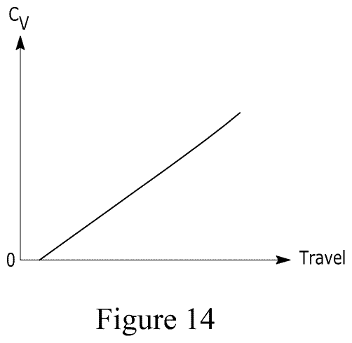

By separating the third sleeve 130 associated with the third stage of the valve trim assembly 124 from the cage assembly 118 where only the first and second stages of the first and second sleeves 126, 128 are disposed, the hole patterns in the first, second, and third sleeves 126, 128, 130 may be a spiral hole pattern. So configured, the flow capacity (Cv) curve is non-step style or a non-step flow capacity curve is achieved, as depicted in FIG. 14, for example. Said another way, the flow capacity (Cv) curve is essentially smooth or forms an essentially smooth line, as depicted in FIG. 14, as a result of the valve trim assembly 124 of the present disclosure. More specifically, the graph in FIG. 14 depicts a flow capacity (Cv) of the cage assembly 118 on a Y-axis and a travel of the valve plug 122 on an X-axis. As depicted, the travel of the valve plug 122 is zero at the closed position, in which the valve plug 122 is not moving, no fluid is flowing through the inlet of the valve body and into the cage assembly 118, and therefore the flow capacity (Cv) of the cage assembly 118 is also zero. When the valve plug 122 begins to move from the closed position to the open position, there is an initial deadband, which is represented by the flow capacity of the cage assembly 118 being zero initially in the graph of FIG. 14. However, as the valve plug 122 continues to move from the closed position to the open position and more fluid is able to flow through the holes of the spiral hole pattern of each of the first sleeve, then the second sleeve, and the third sleeve, the flow capacity (Cv) of the cage assembly 118 continues to increase without deadband in the spiral hole patterns of each of the first, second and third sleeves. This results in a smooth and/or non-step flow capacity curve for the cage assembly 118, as depicted in FIG. 14.

It will be appreciated the valve trim assembly 124 reduces cavitation of the valve seat 120 of the control valve 100, for example, by at least one or more of the following methods. Specifically, a method of reducing cavitation of the valve seat 120 of the control valve 100 using the valve trim assembly 124 comprises coupling the first sleeve 126 of the valve trim assembly 124 to the outer surface 138 of the cage assembly 118, the first sleeve 126 having the spiral hole pattern. The method also includes coupling the second sleeve 128 of the valve trim assembly 124 to the wall 136 of the cage assembly 118, the second sleeve 128 having a spiral hole pattern. The method further includes coupling the third sleeve 130 of the valve trim assembly 124 to the valve plug 122 that is moveable between the closed position and the open position, the third sleeve 130 having a spiral hole pattern. So configured, the deadband 142 of the cage assembly 118 is equal to the deadband 144 of the valve plug 120. The method also includes forming a first pressure recovery area 146 between the first sleeve 126 and the second sleeve 128, and forming the second pressure recovery area 148 between the wall 136 of the cage assembly 118 and the outer surface 138 of the valve plug 122 when the valve plug 122 is in the open position. Upon fluid flowing through one or more of the first, second and third sleeves 126, 128, 130 when the valve plug 122 is in an open position, a flow capacity curve of the cage assembly 118 that is non-step is produced.

In one example, forming the first pressure recovery area 146 between the first sleeve 126 and the second sleeve 128 may further include forming the first pressure recovery area 146 disposed between the inner surface 137 of the wall 136 of the cage assembly 118 and the outer surface 138 of the wall 136 of the cage assembly 118. In addition, forming the second pressure recovery area 148 disposed between the second sleeve 128 and the third sleeve 130 when the valve plug 122 is in the open position may include forming the second pressure recovery area 148 disposed between the inner surface 137 of the wall 136 of the cage assembly 118 and the outer surface 140 of the body of the valve plug 122 when the valve plug 122 is in the open position. In another example, coupling the third sleeve 130 having a spiral hole pattern to the valve plug 122 moveable between the closed position and the open position comprises disposing the third sleeve 130 downstream the seating line 133 of the valve seat 120 and the valve plug 122 when the valve plug 122 is in the closed position, reducing risk of cavitation near the seating line 133, for example.

In view of the foregoing, it will be appreciated that the foregoing valve trim assembly 124 and related methods include at least the following advantages. The valve trim assembly 124 having at least the third sleeve 130 associated with a third stage coupled to the valve plug 122 (and not in the cage assembly as in conventional designs) enables each of the first, second, and third sleeves 126, 128, and 120 to have a spiral hole pattern and a flow capacity Cv curve of the cage assembly 118 to be non-step and/or smooth. The valve trim assembly 124 of the present disclosure includes a large enough area for pressure recovery between every adjacent stage, e.g., the first and second stages, and the second and third stages noted above. Having the non-step flow capacity Cv curve of the cage assembly 118 provides a more accurate control of the control valve 100 and reduces risk of cavitation near the seating line 133 of the valve seat 120 and the valve plug 122.

The figures and description provided herein depict and describe preferred embodiments of the control valve, valve trim assembly, and related method for purposes of illustration only. One skilled in the art will readily recognize from the foregoing discussion that alternative embodiments of the components illustrated herein may be employed without departing from the principles described herein. Thus, upon reading this disclosure, those of skill in the art will appreciate still additional alternative structural and functional designs. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the methods and components disclosed herein without departing from the spirit and scope defined in the appended claims.

What is claimed:

1. A valve trim assembly for a control valve, the valve trim assembly comprising:
a first sleeve having a spiral hole pattern and configured to be coupled to an outer surface of a cage assembly;
a second sleeve having a spiral hole pattern and configured to be coupled to a wall of the cage assembly;
a third sleeve having a spiral hole pattern and configured to be coupled to a valve plug moveable between a closed position and an open position;
a first pressure recovery area disposed between the first and second sleeves; and
a second pressure recovery area configured to be disposed between the cage assembly and an outer surface of the valve plug when the valve plug is in the open position.

2. The valve trim assembly of claim 1, the first sleeve associated with a first stage of the valve trim assembly, the second sleeve associated with a second stage of the valve trim assembly, and the third sleeve associated with a third stage of the valve trim assembly.

3. The valve trim assembly of claim 1, the second sleeve configured to be disposed immediately adjacent to the first sleeve, such that the first sleeve surrounds the second sleeve, and the third sleeve configured to be disposed separate from the first and second sleeves and the cage assembly and around the valve plug.

4. The valve trim assembly of claim 1, the first pressure recovery area disposed between the first sleeve and the second sleeve within the wall of the cage assembly, and the second pressure recovery area configured to be disposed between the second sleeve and the third sleeve when the valve plug is in the open position.

5. The valve trim assembly of claim 1, the wall of the cage assembly having an inner surface and an outer surface, and the valve plug having a body with the outer surface, and the first pressure recovery area disposed between the inner and outer surfaces of the wall of the cage assembly, and the second pressure recovery area configured to be disposed between the inner surface of the wall of the cage assembly and the outer surface of the body of the valve plug when the valve plug is in the open position.

6. The valve trim assembly of claim 1, wherein the third sleeve is disposed downstream a seating line of a valve seat and the valve plug when the valve plug is in the closed position, reducing risk of cavitation near the seating line.

7. The valve trim assembly of claim 1, wherein a deadband of the cage assembly is equal to a deadband of the valve plug, and the deadband of the cage assembly is disposed at an area extending from a first hole at an end of the second sleeve to a seating line of the valve seat and the valve plug, and the deadband of the valve plug is disposed at an area extending from a center line of a first hole at an end of the third sleeve to a seating surface of the valve seat.

8. A control valve comprising:
a valve body having an inlet and an outlet;
a cage assembly disposed within the valve body;
a valve seat coupled to the cage assembly;
a valve plug disposed within the cage assembly, the valve plug moveable between a closed position and an open position; and
a valve trim assembly, the valve trim assembly comprising:
a first sleeve having a spiral hole pattern and coupled to the cage assembly;
a second sleeve having a spiral hole pattern and coupled to a wall of the cage assembly;
a third sleeve having a spiral hole pattern and coupled to the valve plug;
a first pressure recovery area disposed between the first and second sleeves; and
a second pressure recovery area disposed between the cage assembly and an outer surface of the valve plug when the valve plug is in the open position.

9. The control valve of claim 8, wherein a deadband of the cage assembly is equal to a deadband of the valve plug, and the deadband of the cage assembly is disposed at an area extending from a first hole at an end of the second sleeve to a seating line of the valve seat and the valve plug, and the deadband of the valve plug is disposed at an area extending from a center line of a first hole at an end of the third sleeve to a seating surface of the valve seat.

10. The control valve of claim 8, wherein the closed position is a position in which a seating surface of the valve plug contacts the valve seat, and the open position is a position in which the seating surface of the valve plug is removed from the valve seat.

11. The control valve of claim 8, wherein the first sleeve is coupled to an outer surface of a wall of the cage assembly, the second sleeve is coupled to an inner surface of the wall of the cage assembly, and the third sleeve is coupled to an outer surface of the valve plug.

12. The control valve of claim 8, the first sleeve associated with a first stage of the valve trim assembly, the second sleeve associated with a second stage of the valve trim assembly, and the third sleeve associated with a third stage of the valve trim assembly.

13. The control valve of claim 8, the second sleeve is disposed immediately adjacent to the first sleeve, such that the first sleeve surrounds the second sleeve, and the third sleeve is disposed separate from the first and second sleeves and the cage assembly, and around the valve plug.

14. The control valve of claim 8, wherein the first pressure recovery area is disposed between the first sleeve and the second sleeve within the wall of the cage assembly, and the second pressure recovery area is disposed between the second sleeve and the third sleeve when the valve plug is in the open position.

15. The control valve of claim 8, the cage assembly having a wall with an inner surface and an outer surface, and the valve plug having a body with an outer surface, wherein the first pressure recovery area is disposed between the inner and outer surfaces of the wall of the cage assembly, and the second pressure recovery area is disposed between the inner surface of the wall of the cage assembly and the outer surface of the body of the valve plug when the valve plug is in the open position.

16. The control valve of claim 8, wherein the third sleeve is disposed downstream a seating line of the valve seat and the valve plug when the valve plug is in the closed position, reducing risk of cavitation near the seating line.

17. A method of reducing cavitation of a valve seat of a control valve using a valve trim assembly, the method comprising:
coupling a first sleeve of a valve trim assembly to an outer surface of a cage assembly, the first sleeve having a spiral hole pattern;
coupling a second sleeve of the valve trim assembly to a wall of the cage assembly, the second sleeve having a spiral hole pattern;
coupling a third sleeve of the valve trim assembly to a valve plug moveable between a closed position and an open position, the third sleeve having a spiral hole pattern;
forming a first pressure recovery area between the first sleeve and the second sleeve; and
forming a second pressure recovery area between the wall of the cage assembly and an outer surface of the valve plug when the valve plug is in the open position.

18. The method of claim 17, wherein forming a first pressure recovery area disposed between the first sleeve and the second sleeve comprises forming the first pressure recovery area disposed between the first sleeve and the second sleeve within the wall of the cage assembly, and forming a second pressure recovery area between the wall of the cage assembly and an outer surface of the valve plug when the valve plug is in the open position comprises forming the second pressure recovery area between the second sleeve and the third sleeve.

19. The method of claim 17, wherein forming a first pressure recovery area between the first sleeve and the second sleeve comprises forming the first pressure recovery area between an inner surface of a wall of the cage assembly and an outer surface of the wall of the cage assembly, and forming a second pressure recovery area between the wall of the cage assembly and an outer surface of the valve plug when the valve plug is in the open position comprises forming the second pressure recovery area between an inner surface of the wall of the cage assembly and the outer surface of a body of the valve plug when the valve plug is in the open position.

20. The method of claim 17, wherein coupling a third sleeve having a spiral hole pattern to a valve plug moveable between a closed position and an open position comprises disposing the third sleeve downstream a seating line of a valve seat and the valve plug when the valve plug is in the closed position, reducing risk of cavitation near the seating line, wherein a deadband of the cage assembly is equal to a deadband of the valve plug.
